(19) United States
(12) Patent Application Publication
(10) Pub. No.: US 2008/0028901 A1
(43) Pub. Date: Feb. 7, 2008

(54) Method and apparatus for cutting material according to a pattern

(76) Inventor: Anthony W. Johnson, Lorton, VA (US)

Correspondence Address: MEREK, BLACKMON & VOORHEES, LLC, 673 S. WASHINGTON ST, ALEXANDRIA, VA, 22314, US

(21) Appl. No.: 11/498,762

(22) Filed: Aug. 4, 2006

(51) Int. Cl. B26D 1/00; B26D 7/02

(52) U.S. Cl. 83/13; 83/380; 83/451

(57) ABSTRACT

Magnets secure a pattern and a material on a magnetically-attractive substrate, so that the material can be cut accurately and precisely in accordance with the pattern. The magnetically-attractive substrate includes a top layer of a resilient or other material that is well-suited to receive a sharp edge to produce a clean cut in the material being cut. A kit according to the present invention includes a plurality of magnets, preferably of various sizes and shapes, and at least one magnetically-attractive substrate. The kit can have a plurality of substrates, fasteners for holding the substrates together, a cutting tool and packaging.

### BACKGROUND OF THE INVENTION

The present invention relates to cutting pieces of material in connection with a pattern, especially to cutting pieces of material, such as a fabric, to be sewn or otherwise joined to form a garment.

A conventional way of cutting pieces of fabric to be sewn together to form a garment comprises spreading the fabric out flat, pinning thin paper patterns to the fabric, and cutting the fabric around the edges of the patterns. A cutting wheel is often used for the cutting. Pinning the thin paper patterns to the fabric is time-consuming. For greater speed, it is also known to use weights rather than pins to hold the patterns in place on the fabric. A drawback of the use of weights is that weights heavy enough to be effective are so large that they interfere with cutting the fabric at corners and narrow portions of the patterns.

### SUMMARY OF THE INVENTION

By the present invention, magnets are used instead of pins or weights to secure a pattern relative to a material, such as a fabric, so that the material can be cut accurately and precisely in accordance with the pattern. For this purpose, a magnetically-attractive substrate, such as a plate of steel, is placed under the material. As a result, the pattern and the material are clamped between the magnets and the substrate, and the pattern and the material are prevented from moving relative to one another and relative to the substrate. By “magnetically-attractive” is meant a material that is able to attract a magnet or be attracted by a magnet. Preferably, the magnetically-attractive substrate includes a top layer of a resilient or other material that is well-suited to receive a sharp edge, such as that of a cutting wheel, to produce a clean cut in the fabric. It is preferred that the top layer is bonded or otherwise attached to a magnetically-attractive portion of the substrate. Such a substrate is one aspect of the present invention.

A kit according to the present invention includes a plurality of magnets, preferably of various sizes and shapes, and at least one magnetically-attractive substrate. The kit can have a plurality of substrates, a cutting tool and packaging.

### BRIEF DESCRIPTION OF THE DRAWING

FIG. 1 is a schematic plan view of a material cutting apparatus according to the present invention in use in connection with patterns and a piece of material;

FIG. 2 is a partial end view of a material cutting apparatus according to the present invention, with cutting being done with a cutting wheel; and

FIG. 3 is a schematic plan view of a material cutting kit according to the present invention, including a package.

### DETAILED DESCRIPTION OF THE PREFERRED EMBODIMENTS

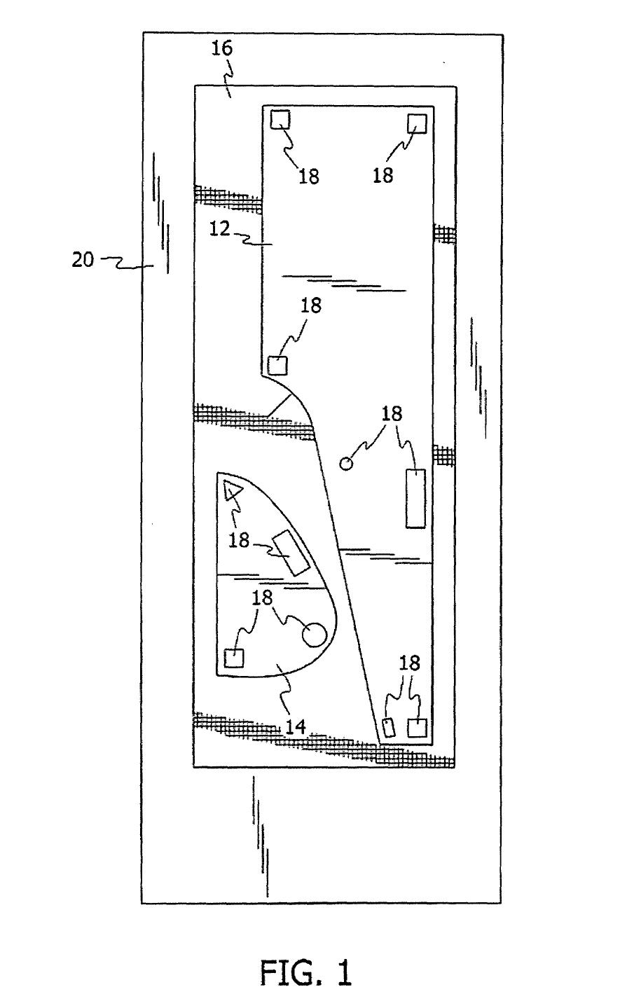

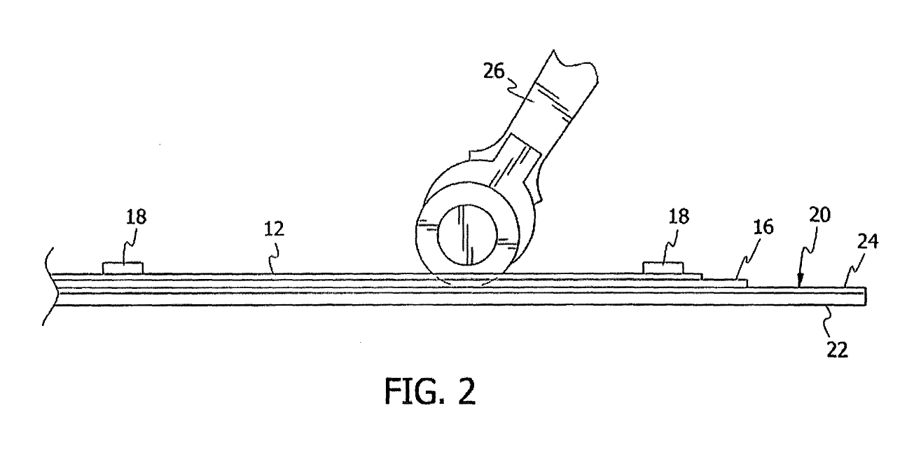

As can be seen from FIGS. 1 and 2, a material cutting apparatus according to the present invention is shown in use with pattern pieces, or patterns, 12 and 14 and a piece of material 16. In one aspect of the present invention, the material cutting apparatus includes magnets 18, which are used instead of pins or weights to secure the patterns 12 and 14 relative to the material 16, such as a fabric, so that the material can be cut accurately and precisely in accordance with the patterns. For this purpose, the material cutting apparatus also includes a magnetically-attractive substrate 20, comprising a magnetically-attractive material 22, for example, a plate of steel, that is placed under the material 16. As a result, the patterns 12 and 14 and the material 16 are clamped between the magnets 18 and the substrate 20, and the patterns and the material are prevented from moving relative to one another and relative to the substrate. As can be appreciated from FIG. 1, the patterns 12 and 14, and other patterns, if needed for a garment or other product, are arranged on the material 16 in a way that minimizes waste of material.

Preferably, the magnetically-attractive substrate 20 also comprises a top layer 24 of a resilient or other material that is well-suited to produce a clean cut in the material, when a sharp edge, such as that of a cutting wheel 26, is applied. A material that is particularly well-suited as the top layer 24 is the material of a conventional self-healing craft mat. It is preferred that the top layer 24 be bonded or otherwise attached to the magnetically-attractive material 22 of the substrate 20. Such a substrate is another aspect of the apparatus according to the present invention.

The present invention will be described further with reference to only the pattern 12, it being understood that the description also applies to the pattern 14 and to other patterns that are not illustrated. The magnetically-attractive material 22 defines a magnetically-attractive area that is at least as large as the area of the pattern 12 with which the substrate is being used. The magnets 18 are adapted to hold the material 16 to be cut and the pattern 12 to the magnetically-attractive area by magnetic attraction. In this regard, it is important that each magnet 18 be strong enough to hold the pattern 12 and the material 16 firmly. Like the magnetically-attractive material 22, the top layer 24 has an area at least as large as the area of the pattern 12.

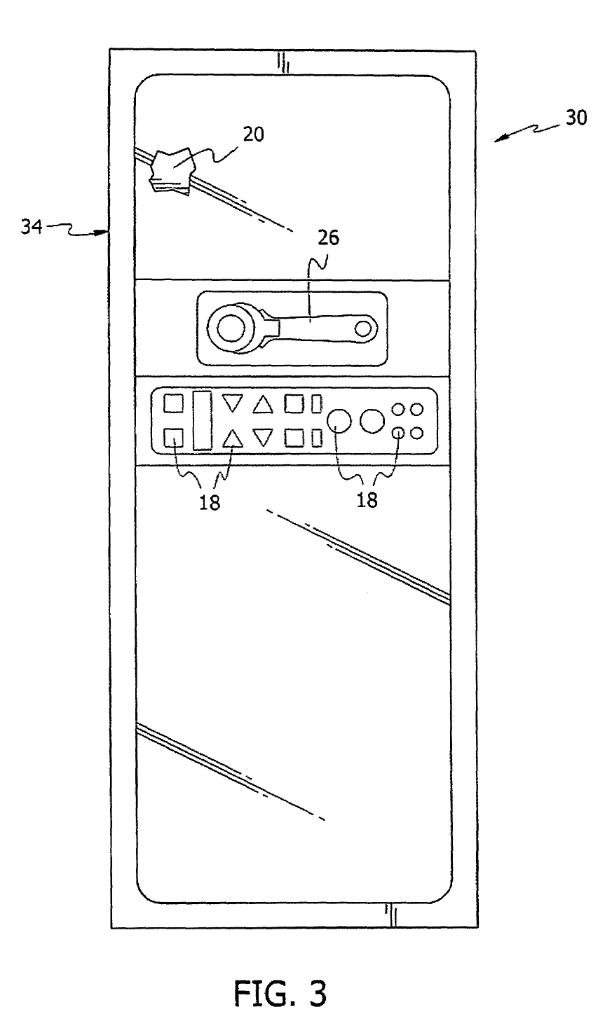

As can be appreciated from FIG. 3, a kit 30 according to the present invention includes a plurality of magnets 18, preferably of various sizes and shapes, and at least one magnetically-attractive substrate 20. Some magnets 18 can be relatively long and thin, for example, about ½ inch wide and 1 inch or more long, to fit into long, narrow pattern shapes. Other magnets can be triangular, having, for example, the shape of an equilateral triangle, to fit into pattern shapes having relatively sharp angles. Other magnets can be square, and still others can be circular. It is preferred that the kit 30 have at least twenty magnets 18.

The kit 30 can have a plurality of the substrates 20, or substrate sections, that can be used individually or secured together along their edges to form a single substrate of larger area. For such securing, the kit 30 can include clips or other conventional fasteners (not shown). Where the kit 30 has a plurality of substrates 20, all of the substrates can have the same shape and size, for example, a rectangular shape of about 3 feet by 4 feet, or the substrates can have differing sizes and/or shapes. The kit can also include a cutting tool 26, such as a cutting wheel. Packaging 34 can hold together all of the parts of the kit 30 for sale and storage. In the illustrated packaging 34, a plurality of the substrates 20 can be held one in front of the other such that only the front substrate is visible, especially where all of the substrates 20 are of the same size and shape.

The present invention also relates to a method for cutting material in connection with a pattern. In accordance with the method, which, for convenience, is described in connection with the apparatus disclosed herein, material 16 to be cut is put on, and spread out on, a substrate 20 having a magnetically-attractive area, defined by a magnetically-attractive material 22, that is at least as large as the area of a pattern 12. The pattern 12, which can be a conventional sewing pattern made of thin paper, is spread out on the material 16 such that the magnetically-attractive area underlies the entire pattern, with the material to be cut interposed between the pattern and the magnetically-attractive area. When the material 16 and the pattern 12 are spread out and smooth, magnets 18 are positioned on the pattern 12 to restrain movement of the pattern and the material relative to one another and relative to the substrate 20. The magnets 18 are positioned near the edges and corners of the pattern, and in spaced relationship with one another. The magnets 18 are typically positioned such that the edge of each magnet that is the closest to the edge of the pattern 12 is about ¼ inch to 1 inch from the edge of the pattern. Then, the material 16 is cut by pressing a cutting edge, such as that of a cutting wheel 26, into the material and moving the cutting wheel along the outline provided by the pattern 12, while the material is supported by the substrate 20. The substrate 20 can have a second material 24 adapted to receive a cutting edge in a manner that results in an even cut in the material to be cut, in which case the pattern 12 is preferably placed entirely on the second material.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

1. A kit for cutting material in connection with a pattern having an area comprising:
at least one substrate having a first material having a magnetically-attractive area at least as large as the area of the pattern; and
magnets adapted to hold to the magnetically-attractive area by magnetic attraction the pattern and material to be cut.

2. The kit according to claim 1, wherein the magnetically-attractive area comprises a plate made of a magnetically-attractive material, said plate having an area at least as large as the area of the pattern.

3. The kit according to claim 2, wherein the at least one substrate further comprises a second material adapted to receive a cutting edge in a manner that results in an even cut in the material to be cut, the second material being secured to the magnetically-attractive material and having an area at least as large as the area of the pattern.

4. The kit according to claim 3, wherein the second material is a resilient material.

5. The kit according to claim 1, wherein the at least one substrate comprises a plurality of substrates.

6. The kit according to claim 1, wherein the magnets comprise at least one rectangular magnet having a width of about ½ inch.

7. The kit according to claim 1, wherein the magnets comprise at least one magnet having the shape of an equilateral triangle.

8. The kit according to claim 1, further comprising packaging holding together the at least one substrate and the magnets.

9. The kit according to claim 1, further comprising a cutting instrument adapted to cut material by pressing the material against the at least one substrate.

10. A substrate for cutting material in connection with a pattern having an area comprising:
a first material having a magnetically-attractive area; and
a second material different from said first material, the second material being adapted to receive a cutting edge in a manner that results in an even cut in the material to be cut and being secured to the magnetically-attractive material.

11. The substrate according to claim 10, wherein the magnetically-attractive area comprises a plate made of a magnetically-attractive material, said plate having an area at least as large as the area of the pattern.

12. The substrate according to claim 10, wherein the second material is a resilient material.

13. The substrate according to claim 10, wherein the substrate comprises a plurality of sections.

14. The substrate according to claim 10, wherein the magnetically-attractive area is at least as large as the area of the pattern, and the second material has an area at least as large as the area of the pattern.

15. A method for cutting material in connection with a pattern having an area comprising:
putting material on a substrate having a magnetically-attractive area that is at least as large as the area of the pattern;
placing the pattern on the material such that the magnetically-attractive area underlies the entire pattern, with the material interposed between the pattern and the magnetically-attractive area; and
positioning at least one magnet on the pattern to restrain movement of the pattern and the material relative to one another and relative to the substrate.

16. The method according to claim 15, further comprising cutting the material in accordance with the pattern.

17. The method according to claim 16, wherein the cutting comprises pressing a cutting edge into the material while the material is supported by the substrate.

18. The method according to claim 15, wherein the magnetically-attractive area by a magnetically-attractive material of the substrate, and the method further comprises providing the substrate with a second material adapted to receive a cutting edge in a manner that results in an even cut in the material to be cut, wherein the placing comprises placing the pattern entirely on the second material.

19. The method according to claim 15, wherein the magnetically-attractive area by a magnetically-attractive material of the substrate, and the method further comprises providing the substrate with a resilient material adapted to receive a cutting edge in a manner that results in an even cut in the material to be cut, wherein the placing comprises placing the pattern entirely on the resilient material.

20. The method according to claim 15, wherein the positioning comprises positioning a plurality of magnets on the pattern and in spaced relationship with one another.

21. The method according to claim 20, wherein the positioning comprises positioning a plurality of magnets adjacent to edges of the pattern.
